(19) United States
(12) Patent Application Publication
(10) Pub. No.: US 2024/0279511 A1
(43) Pub. Date: Aug. 22, 2024

(54) HAIR REMOVING AND SCULPTING APPARATUS, SYSTEMS, AND METHODS

(71) Applicant: Robert Falken, San Diego, CA (US)

(72) Inventor: Robert Falken, San Diego, CA (US)

(21) Appl. No.: 18/444,657

(22) Filed: Feb. 17, 2024

Related U.S. Application Data
(60) Provisional application No. 63/446,799, filed on Feb. 17, 2023.

(51) Int. Cl. C09J 7/38; C09J 7/20; C09J 7/21

(52) U.S. Cl. CPC C09J 7/383; C09J 7/201; C09J 7/203; C09J 7/21; C09J 2301/122; C09J 2301/302; C09J 2407/00; C09J 2423/00

(57) ABSTRACT

An advanced hair removal and sculpting apparatus and method is disclosed, which includes specially designed hair removing strips, an applicator stick, and an applicator stick system. The hair removing strips are a central innovation of the present apparatus, tailored in various sizes and shapes for different body contours. These strips are constructed from skin-friendly materials with a unique pressure-sensitive adhesive layer, capable of effectively removing hair from body areas with minimal discomfort. The applicator stick features an adhesive coated tip at one end that comprises a unique pressure-sensitive adhesive. This applicator stick is adept at precisely removing hair, particularly nose, ear, and eyebrow hairs. The adhesive formulation of the present invention balances strong hair adherence with gentle removal, incorporating soothing agents for skin care. This apparatus offers a comprehensive solution for both precision sculpting and efficient hair removal across the body and face, aligning with modern grooming needs.

### CROSS-REFERENCE TO RELATED APPLICATIONS

This application claims the benefit of priority to co-owned and co-pending U.S. Provisional Application Ser. No. 63/446,799, filed on Feb. 17, 2023, and entitled “Facial Hair Removing and Sculpting Apparatus,” which is incorporated into the present application by reference in its entirety.

### COPYRIGHT

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND OF THE INVENTION

The evolution of grooming and hair removal techniques has been a constant endeavor in human history, reflecting cultural, aesthetic, and personal hygiene preferences. The present invention relates to advancements in grooming and hair removal techniques, particularly in the development of a novel facial and body hair removing and sculpting apparatus. The focus of the present invention presents a transformative shift from conventional hair removing apparatus and methods to the use of new and improved apparatus, systems, and methods for hair removal and sculpting utilizing new and improved hair removing apparatuses, including hair removing strips, that also utilize new and improved hair removing adhesive, which are designed to cater to the nuanced demands of modern grooming practices.

Historically, hair removal has been a practice rooted in various cultural and social norms. Its significance has escalated with changing fashion trends, personal grooming standards, and the growing awareness of body aesthetics. Traditional hair removal methods, while widely used, have been associated with several challenges. Shaving, one of the oldest methods, often leads to rapid regrowth of hair and poses a risk of skin cuts and abrasions. Tweezing, another common practice, is time-consuming, painful, and requires exceptional hand-eye coordination. Waxing, though effective for longer-lasting results, often involves a messy clean-up process and can cause significant discomfort. Chemical depilatories, while offering an alternative, come with their own set of drawbacks, including potential skin irritation and allergic reactions.

The specific challenge of facial hair grooming, especially in the context of eyebrow shaping and sculpting, highlights the limitations of these traditional methods. Eyebrows play a crucial role not only in facial aesthetics but also in non-verbal communication, making their grooming a delicate task. Existing methods like plucking, threading, or using heated wax, require precision and can be quite cumbersome and painful. Moreover, these methods often demand professional skills or a visit to a salon, adding to the inconvenience for individuals seeking a quick and easy grooming solution at home.

The current landscape of hair removal and grooming products reveals a significant gap in the market: the need for an apparatus and method that is quick, effective, convenient, and gentle on the skin, as well as being suitable for both facial and body hair removal. This gap is particularly evident for individuals who prefer at-home grooming solutions over professional services. The demand for a user-friendly, efficient, and skin-sensitive apparatus and method of hair removal has been growing, underlining the need for innovation in this domain.

Based on the foregoing, improved apparatuses, systems, and methods for hair removal and sculpting are greatly needed, including apparatuses, systems, and methods that utilize new and improved hair removing strips designed for various body contours that further utilize a new and improved hair removing adhesive, which combine ease of use with efficiency, speed, and skin-friendliness.

### SUMMARY OF THE INVENTION

This invention introduces a unique hair removal and grooming apparatus, primarily centered around the concept of hair removal strips. These strips represent a leap forward in personal grooming technology, offering a solution that is in line with contemporary needs for efficiency, speed, and comfort.

The apparatus, as detailed herein, encompasses a range of hair removal strips, each designed with specific body contours in mind. From delicate facial areas to broader body zones, these strips are available in various sizes and shapes, ensuring a precise and comfortable fit for effective hair removal. This approach marks a significant departure from traditional methods, providing a versatile and adaptable solution for diverse grooming requirements.

The key innovation of this apparatus lies in the specialized design and composition of the hair removal strips and the formulation of the adhesive layer disclosed herein. The strips are crafted from high-quality, skin-friendly materials, ensuring suitability for all skin types, including sensitive skin. This balance between efficacy and gentleness is a crucial aspect of the invention, addressing one of the primary concerns associated with hair removal.

The apparatus, primarily in a hair removal strip format as disclosed herein, consists of three components: a backing layer material, an adhesive layer, and a release liner. To use the apparatus, the user first peels off the release liner, revealing the customized adhesive on the backside of the backing layer material. The user then places the strip on the skin at the targeted hair removal area, ensuring proper alignment. This alignment is crucial so that when the user pulls the clearly identifiable pull-tab on the strip, it is done so in the direction of hair growth. This design ensures ease of use and effectiveness for both at-home grooming enthusiasts and professionals.

Several non-limiting examples of the preferred backing layer materials of the present invention are woven fabric, non-woven fabric, non-woven interfacing, fusible web, spunbond fabric, or the like. The preferred backing layer materials are selected from those that are environmentally safe such as cotton fabric, cellulosic fabric, such as those marketed under the brand names Lyocell and Modal, polylactic acid (PLA) fabric, and the like. Still further, fabric selections of the backing layer materials may consist of polyester that is preferably 100% recycled, linen, hemp, silk, wool, jute, and even more exotic fabrics such as those derived from apples, pineapples, mushrooms, cactus, CO2, and the like. The optimal fabric weight of the backing layer is between 50 and 120 Grams per Square Meter (GSM), and more preferably between 70 GSM and 100 GSM.

The adhesive layer used on these strips is a customized compound or blend, optimized for strong hair adherence while ensuring minimal discomfort during the removal process. Further adhesive details will be outlined in the detailed description that follows.

Other features and advantages of the present invention will immediately be recognized by persons of ordinary skill in the art with reference to the accompanying drawings and detailed description of exemplary embodiments as discussed herein.

### BRIEF DESCRIPTION OF THE DRAWINGS

The accompanying drawings illustrate various aspects and embodiments of the present invention disclosed herein but should not be construed as restricting the scope of the invention in any manner. The disclosed embodiments have other advantages and features which will be more readily apparent from the following detailed description of the invention and the claims, when taken in conjunction with the accompanying drawings. In the drawings, like reference numerals refer to the same or similar elements or components.

FIG. 1 is a perspective view illustrating an exemplary embodiment of a hair removal and sculpting apparatus with a pull-tab portion and a hair removal portion according to the present invention.

FIG. 2 is a perspective view illustrating an embodiment of a hair removal and sculpting apparatus according to the present invention depicted in FIG. 1.

FIG. 3 is another perspective view illustrating an embodiment of a hair removal and sculpting apparatus according to the present invention depicted in FIGS. 1-2.

FIG. 4 is a cross-sectional view illustrating an embodiment of a hair removal portion of a hair removal and sculpting apparatus according to the present invention depicted in FIGS. 1-3.

FIG. 5 is another cross-sectional view illustrating an embodiment of a pull-tab portion of a hair removal and sculpting apparatus according to the present invention depicted in FIGS. 1-4.

FIG. 6 is another perspective view illustrating an embodiment of a hair removal and sculpting apparatus having a release liner slightly peeled back according to the present invention depicted in FIGS. 1-5.

FIG. 7 is yet another perspective view illustrating an embodiment of a hair removal and sculpting apparatus having a release liner peeled back exposing an adhesive layer according to the present invention depicted in FIGS. 1-6.

FIG. 8 is still another prospective view illustrating another embodiment of a hair removal and sculpting apparatus having an applicator stick according to the present invention.

FIG. 9 is yet another prospective view illustrating yet another embodiment of a hair removal and sculpting apparatus having an applicator stick system according to the present invention.

### DETAILED DESCRIPTION OF THE INVENTION

Various aspects and embodiments of the apparatus and methods of the present invention are now described in detail. In the following detailed description, reference is made to the accompanying drawings which form a part hereof, wherein like numerals designate like parts throughout, and in which is shown, by way of illustration, embodiments that may be practiced.

The present invention is directed to new and improved facial and body hair removing and sculpting apparatuses, systems, and methods that utilize new and improved hair removing strips and an adhesive formulation designed for various body contours, which combine ease of use with efficiency, speed, and skin-friendliness. Although the apparatus, systems, and methods of the present invention are described primarily with respect to use of hair removal strips for grooming eyebrows, the present invention may be readily adapted to other hair removal and grooming needs as discussed below. Hence, it is to be understood that other embodiments may be utilized, and structural changes may be made without departing from the scope of the present disclosure. Therefore, the following detailed description is not to be taken in a limiting sense, and the scope of embodiments is defined by the appended claims and their equivalents.

Aspects of the disclosure are disclosed in the accompanying description. Alternate embodiments of the present disclosure and their equivalents may be devised without departing from the spirit or scope of the present disclosure. It should be noted that any discussion herein regarding “one embodiment,” “an embodiment,” “an exemplary embodiment,” and the like indicate that the embodiment described may include a particular feature, structure, or characteristic, and that such particular feature, structure, or characteristic may not necessarily be included in every embodiment. In addition, references to the foregoing do not necessarily comprise a reference to the same embodiment. Finally, irrespective of whether it is explicitly described, one of ordinary skill in the art would readily appreciate that each of the particular features, structures, or characteristics of the given embodiments may be utilized in connection or combination with those of any other embodiment discussed herein.

Various steps, operations, or actions may be described as multiple discrete steps, operations, or actions in turn, in a manner that is most helpful in understanding the claimed subject matter. However, the order of description should not be construed as to imply that these steps, operations, or actions are necessarily order dependent. In particular, these steps, operations, or actions may not be performed in the order of presentation. Steps, operations, or actions described may be performed in a different order than the described embodiment. Various additional steps, operations, or actions may be performed and/or described steps, operations, or actions may be omitted in additional embodiments.

### Exemplary Hair Removing Strips

Central to the present invention are new and unique hair removing strips as disclosed herein. Designed for various body contours, these hair removal strips are available in multiple sizes and shapes, each meticulously engineered for specific areas, locations, and parts of the human body. For facial use, smaller, more flexible strips are tailored for precision in areas like eyebrows and upper lips. Larger strips are designed for broader body areas such as legs and underarms, offering efficient hair removal over larger surfaces.

The ergonomic design of the hair removal strips, along with the clearly identifiable pull-tabs, are key features. The hair removal strips are crafted to conform seamlessly to body contours, ensuring effective hair adherence and removal. This is achieved through a combination of material flexibility and strategic shaping, allowing the strips to adhere closely to the skin and capture hairs effectively, even in curved or hard-to-reach areas.

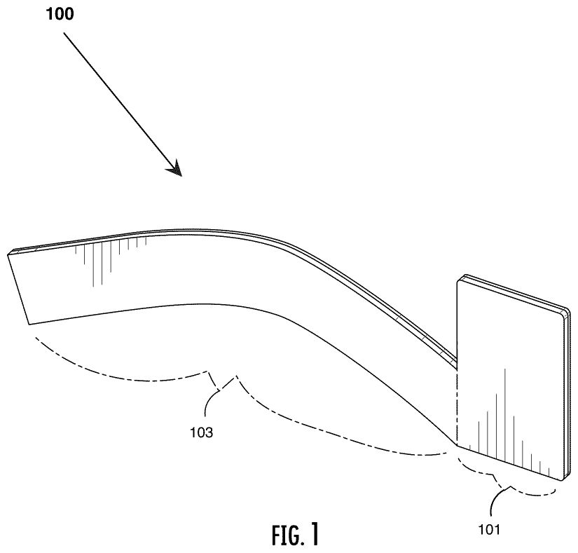

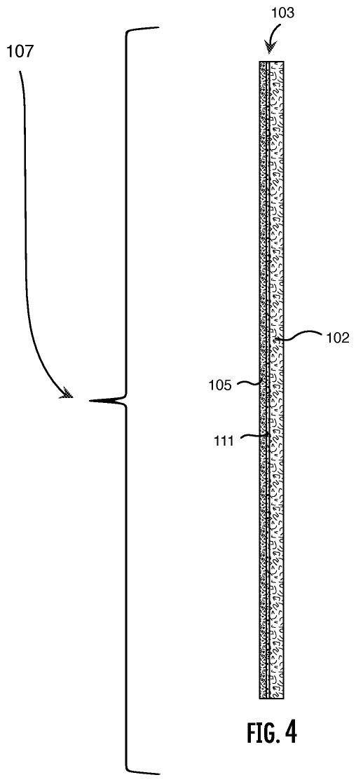

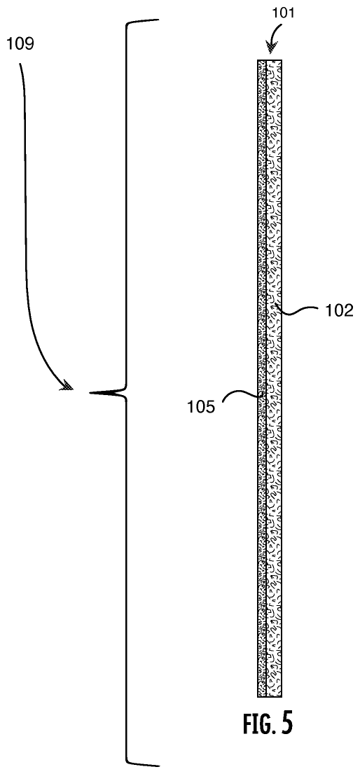

FIG. 1 depicts an embodiment of the hair removal and sculpting apparatus according to the present invention that comprises a hair removal strip 100 comprising a pull-tab portion 101 and a hair removal portion 103. Both the pull-tab 101 and the hair removal portion 103 are constructed from a backing layer material (as discussed below in connection with FIGS. 4-5). In one variant, pull-tab 101 extends perpendicularly from one end of the hair removal portion 103, allowing the user to effectively grip and maneuver the hair removal strip 100. It is also contemplated that the hair removal portion 103 can be elongated with a curvature conforming to the ergonomic requirements for ease of application to various body contours of a human body. This embodiment demonstrates the simplicity and user-friendly design of the hair removal strip 100, providing efficient hair removal through a combination of material choice and structural design. It is contemplated that hair removal strip 100 may be formed in a variety of shapes, sizes, and dimensions for hair removal applications to the natural arch of an eyebrow, or any other desired portion of a human body. Several non-limiting examples of the contemplated facial portions targeted for removing hair are the underside of the eyebrows, commonly referred to as the “arch,” above the eyebrows, beside the eyebrows, and between the eyebrows. Additional non-limiting examples of the contemplated facial portions targeted for hair removal are the upper lip, chin, cheeks, sideburn-area, on or in the outer ear, the end of the nose, and inside the outer portion of the nostrils. Still further, non-limiting examples of the contemplated bodily portions targeted for hair removal, in no specific order, are the armpits, hands, forearms, all portions of the back, chest, bikini area, groin area, legs, thighs, and toes.

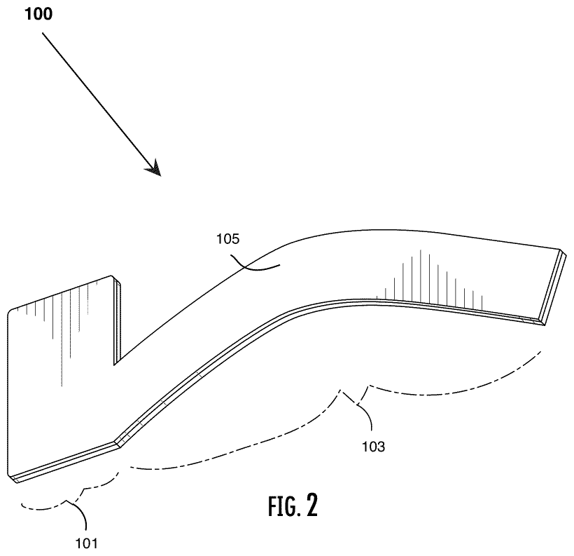

FIG. 2 depicts the hair removal strip 100 according to the present invention. Featured prominently in this view is the release liner 105, which fully covers the backside surface of the pull-tab portion 101 and the hair removal portion 103 of the disclosed embodiment. The release liner 105 is designed to conform precisely to the contours of the hair removal strip 100 and thereby cover an adhesive layer (not shown) disposed thereunder. The release liner 105 serves multiple purposes, such as protecting the adhesive or treatment surface prior to use or enabling easy handling and positioning of the apparatus against the skin. Its material composition is chosen to preserve the integrity of the hair removal adhesive layer until it is ready for activation by the user. This view underscores the simplicity of the apparatus's design, which facilitates both the protective aspects of the release liner 105 and the functional ergonomics of the apparatus.

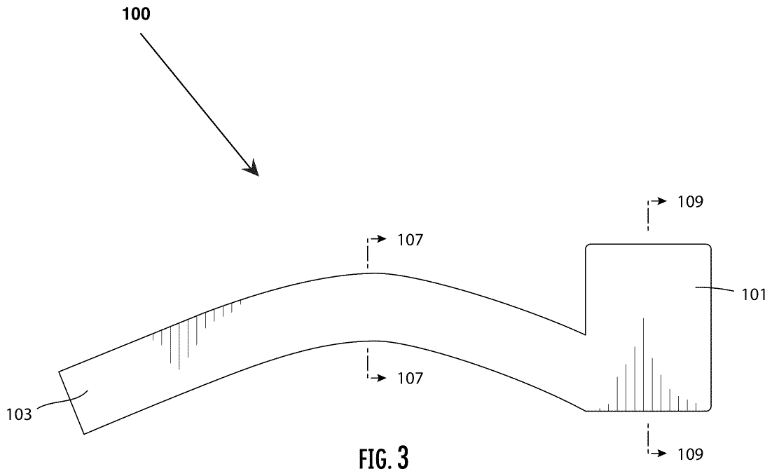

FIG. 3 depicts an embodiment of the hair removal strip 100 according to the present invention that depicts cross-sectional reference lines as follows: (i) cross sectional reference line 107 pertains to the cross-sectional view of hair removal portion 103 as shown in

FIG. 4; and (ii) cross sectional reference line 109 pertains to the cross-sectional view of the pull-tab portion 101 as shown in FIG. 5. The hair removal portion 103, with its precise curvature, is designed to adhere to the skin's surface efficiently, while the pull-tab portion 101 is structured for a firm grip and effective control during the hair removal process from a portion of a human body. The cross-section references are strategically positioned to provide a clear understanding of the internal configuration and the interaction of the components within hair removal strip 100.

FIG. 4 depicts a cross-sectional view along the reference line 107 (as shown in FIG. 3) of the hair removal portion 103 of the hair removal strip 100 according to the present invention. Hair removal portion 103 comprises a backing layer 102, which serves as a carrier substrate for, and to provide structural support to, the adhesive layer 111. Affixed to the one side of the backing layer 102 (as shown in FIG. 4) is the adhesive layer 111, which enables the hair removal strip 100 to adhere securely to the skin during the hair removal process. Further, as shown in FIG. 4, a release liner 105 is removably coupled to the adhesive layer 111 and is designed to protect adhesive layer 111 until the hair removal strip 100 is ready for use. The detailed textures and material boundaries shown in FIG. 4 are depicted to emphasize the distinct properties of each layer within the hair removal portion 103 of the hair removal strip 100 according to the present invention.

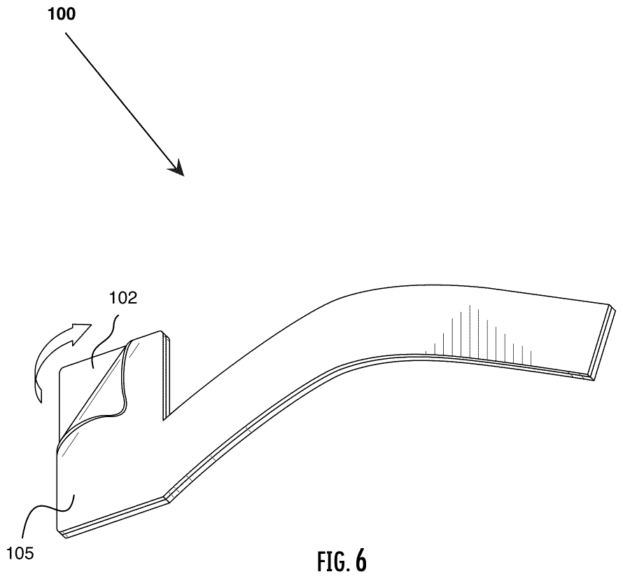

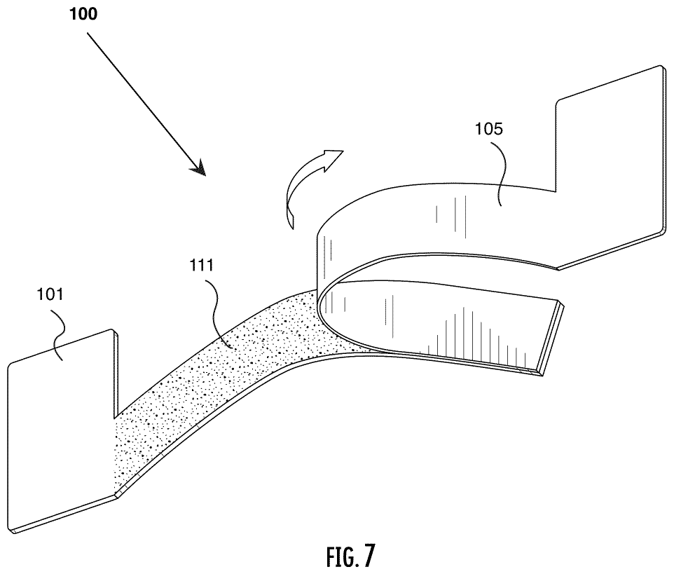

FIG. 5 depicts a cross-sectional view along the reference line 109 (as shown in FIG. 3) of the pull-tab portion 101 of the hair removal strip 100 according to the present invention. As shown, pull-tab portion 101 comprises a backing layer 102 and the release liner 105. Notably, the pull-tab portion 101 lacks an adhesive layer 111, distinguishing its functionally from the hair removal portion 103 depicted in FIG. 4. The release liner 105 is not bonded to the backing layer 102; instead, it is placed in proximity to the backing layer as part of the manufacturing process to enable a clean die-cut or laser-cut of the final product shape of hair removal strip 100. During use, the user can easily grasp the release liner 105 on the pull-tab portion 101 and pull it apart from the backing layer 102. This action separates the two components and exposes the adhesive layer 111 of the hair removal portion 103 as shown in FIGS. 6-7.

FIG. 6 depicts an embodiment of the hair removal strip 100 according to the present invention. In this view, the backing layer 102 is visible. Additionally, the release liner layer 105 is depicted in the process of being peeled back from the pull-tab portion 101, demonstrating the initial step a user would take to prepare the hair removal strip 100 for application to a portion of a human body for hair removal. The peeling action exposes the adhesive layer (not shown in FIG. 6) that adheres to the skin for hair removal. The peeling angle and the partial detachment of the release liner 105 from the backing layer 102 are captured in a manner that suggests ease of separation, emphasizing the user-friendly design of the hair removal strip 100. It is contemplated that the backing layer 102 of the hair removal strip 100 is flexible in nature, while at the same time maintaining its structural integrity so that the release liner 105 can be removed in a peeling fashion, which is an important feature for the usability of the hair removal strip 100.

FIG. 7 depicts an embodiment of the hair removal strip 100 according to the present invention, which depicts the release liner 105 being almost completely removed from strip 100. As shown in FIG. 7, the peeling of the release liner 105 reveals adhesive layer 111, which is ready for application to a portion of skin of a user's body for removing unwanted hair.

The process begins at the pull-tab portion 101, where backing layer 102 serves as a handle for the user to initiate peeling of release liner 105. This view showcases the adhesive layer's coverage across the hair removal portion 103 of hair removal strip 100, indicating the area that contacts a portion of a person's skin for hair removal. The adhesive layer 111 is uniformly spread across the hair removal portion 103 to ensure consistent adhesion and effective hair removal across the desired portion of skin. FIG. 7 illustrates the transition from an inactive state of hair removal strip 100 to an active state for removing hair, emphasizing the simplicity and ease of preparation inherent in the design of the hair removal strip 100.

It is contemplated that hair removal strip 100 is constructed from a blend of materials chosen for their skin compatibility, durability, and eco-friendliness. Options include backing layers such as hypoallergenic fabrics, biodegradable substances, and other innovative materials that provide strength and flexibility while being gentle on the skin. The choice of material is crucial in ensuring that the hair removal strips can be used comfortably by individuals with different skin types, including those with sensitive skin. Several non-limiting examples of the preferred materials for backing layer 102 are woven fabric, non-woven fabric, non-woven interfacing, fusible web, spunbond fabric, or the like. The preferred material for backing layer 102 are selected from those that are environmentally safe such as cotton fabric, cellulosic fabric, such as those produced in the Lyocell and Modal process, polylactic acid (PLA) fabric, and the like. Still further, fabric selections of the backing layer 102 may consist of polyester that is preferably 100% recycled, linen, hemp, silk, wool, jute, and even more exotic fabrics such as those derived from apples, pineapples, mushrooms, cactus, CO2, and the like. The optimal fabric weight of the backing layer is between 50 and 120 Grams per Square Meter (GSM), and more preferably between 70 GSM and 100 GSM.

Each hair removal strip 100 features a specially formulated adhesive layer 111 (as discussed below). This adhesive layer 111 is the result of extensive research and development, designed to balance strong hair adherence with ease of removal. The formulation of adhesive layer 111 ensures that the hair removal strips 100 can effectively remove hair of various thicknesses and lengths while minimizing discomfort, skin irritation, and residual adhesive left on a user's skin after application of the hair removal strip. The preferred adhesive layer coating thickness is between 250 microns and 1250 microns, and more preferably between 350 microns and 500 microns. If the coating thickness is too thin, then the adhesive force of the hair removal can be too low for successfully removing hair. Inversely, if the adhesive layer coating thickness is too thick, then there is an increased possibility for adhesive layer residue to remain on the skin after the hair removal strip is removed.

Each hair removal strip 100 includes a release liner 105 securely attached to the adhesive layer 111. This release liner 105 is preferably made from polyethylene-coated bleached kraft paper, weighing between 80 grams per square meter and 160 grams per square meter, and more preferably between 130 grams per square meter and 150 grams per square meter. Further, it is contemplated that release liner 105 has a silicone coating on the side that directly contacts the adhesive layer 111. The release liner 105 is designed for easy removal from the adhesive layer 111; it can be peeled off effortlessly and then appropriately discarded, or if desired re-adhered to the adhesive layer 111 for later use.

### Exemplary Hair Removing Applicators

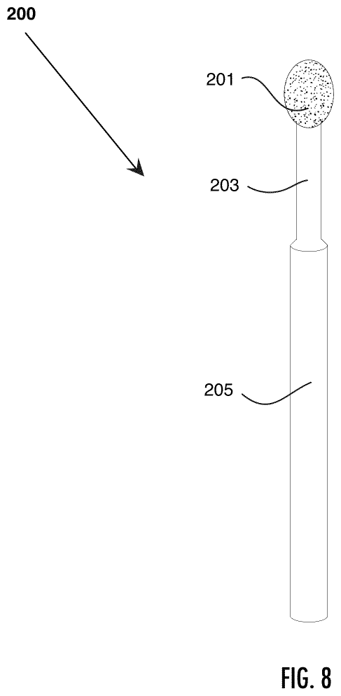

In alternative embodiments, as depicted in FIG. 8, the hair removal and sculpting apparatus comprises an applicator stick 200 with a handle portion 205 and an oppositely situated application end comprising an adhesive coated top 201. In one variant, applicator stick 200 comprises an adhesive coated tip 201 that is optimized for efficient hair capture in the ear and nose region. In other variants, adhesive tip 201 may also assume a crescent or semicircular shape, aligning with the natural arch of the eyebrow, and is adaptable to a range of eyebrow shapes and sizes. Advanced adhesive deposition techniques, such as deposition machines or dipping methods, are used for application of the adhesive onto the tip or spheroidal assemblage. The adhesive material's hot-melt properties ensure ease of deposition and consistent application.

Extending from the adhesive coated tip 201 is a bendable stick portion 203. The bendable stick portion 203 is constructed to allow flexibility, providing ease of use and the ability to reach different angles during hair removal. This feature enables the user to manipulate the angle of the adhesive coated tip 201 without breaking or damaging the applicator stick 200.

At the opposite end of the bendable stick portion 203 is a handle portion 205. The handle portion 205 is designed for the user to hold and control the applicator stick comfortably and securely during use. It is proportioned to allow a firm grip, thus facilitating precision in the application of the adhesive coated tip 201 to the desired area for hair removal. In one variant, the applicator stick 200 can be made from materials like plastic, bioplastic, molded paper, or metal for durability and user comfort. In other variants, applicator stick 200 is preferably elongated and cylindrical, with a diameter of between 0.5 and 10 millimeters, and preferably between 1 and 5 millimeters. In additional variants, applicator stick 200 can have a length of between 2 and 20 centimeters, and more preferably between 3 and 10 centimeters.

As shown in FIG. 8, applicator stick 200 provides an effective tool for hair removal, combining an adhesive coated tip 201 (wherein an adhesive layer (not shown in FIG. 8) is applied to the tip in accordance with the disclosure about the adhesive layer discussed in paragraphs 49-63) with a bendable stick portion 203 and a handle portion 205, all designed to optimize the hair removal process for the user. In operation, the user holds the applicator stick 200 by the handle portion 205 and applies the other end to the target hairs, with the adhesive material effectively gripping the hair for removal.

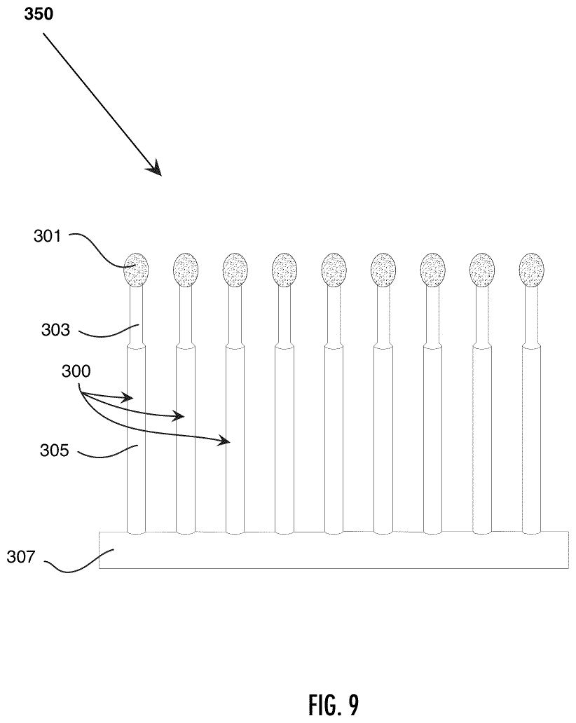

In an alternative embodiment, as depicted in FIG. 9, an applicator stick system 350 is disclosed that comprises a plurality of hair removal applicator sticks 300 (200 as shown and described in FIG. 8), wherein multiple applicator sticks are organized and affixed to a coupling member 307. Each applicator stick includes an adhesive coated tip 301, designed to adhere to and remove hair from the skin. The adhesive coated tips 301 are uniformly aligned and spaced to facilitate simultaneous preparation or application of multiple hair removal procedures.

Directly beneath each adhesive coated tip 301 is a bendable stick portion 303, which allows for individual flexibility of each stick within the system 350. This flexibility ensures that each stick can be adjusted independently to the contours of the skin or to the user's preference, without affecting the position of the other sticks in the system.

The bendable stick portions 303 are mounted on a handle portion 305 that extends horizontally, wherein the handle portion 305 of each stick 300 is removably coupled to coupling member 307, serving as a common base for all the sticks 300 in the system 350. The coupling member 307 provides stability and a unified grip for the user to handle multiple sticks simultaneously.

At the base of the system is a coupling member 307, which removably holds each of the removal applicator sticks 300 in place. Each of the hair removing applicator sticks 300 can be selectively removed from the coupling member 307. The coupling member 307 allows for easy storage and organization of the hair removal applicator sticks 300, as well as potentially allowing for single-use or multi-use configurations, depending on the design. In summary, FIG. 9 depicts a novel arrangement of hair removal applicator sticks 300 into an applicator stick system 350 that optimizes the hair removal process by providing a system that allows multiple hair removal applicator sticks to be used and managed efficiently.

The arrangement or set of hair removal applicator sticks 300 can be enclosed in a packaging enclosure (not shown), such as a “clam shell” encasement or housing or the like. Further, it is contemplated that some embodiments of the applicator stick system 350 that the encasement, enclosure, or housing includes a bridge or ridge to keep the adhesive tips 301 of each stick 300 spaced apart from an inner wall of the encasement, enclosure, or housing, yet allow a user to grasp the handle portion 305 of the applicator stick 300. In some further implementations, the packaging enclosure may contain an ultraviolet light inhibitor to prevent loss of properties or performance of the adhesive layer on the applicator sticks when exposed to light at the point of sale.

While being depicted in FIG. 9 as a set of hair removal applicator sticks 300 arranged in linear fashion into an applicator stick system 350, in yet other embodiments, the hair removal applicator stick system 350 can include a circular or multi-dimensional arrangement of hair removal applicator sticks 300, each removably coupled to a coupling member 307. Further, it is contemplated that coupling member 307 can be integrated with the encasement, enclosure, or housing, i.e., formed as part of the encasement, enclosure, or housing, or may be a separate entity and removable from the encasement, enclosure, or housing.

### Exemplary Adhesive Formulations

The adhesive layer according to the present invention as utilized with the hair removal strip (depicted by reference numeral 111 as shown in FIGS. 1-7) or the hair removal applicator stick or system (applied to the adhesive coated tip 201 as shown in FIGS. 8 and 301 as shown in FIG. 9) is discussed in further detail below. It is contemplated that the adhesive layer comprises a blend of advanced adhesives, optionally including medical-grade ingredients, to ensure safety and effectiveness. The adhesive layer is developed to provide optimal peel strength, ensuring that it grips hair firmly for efficient removal while being easy to peel off the skin. Preferably, the adhesive layer complies with the International Organization for Standardization (ISO) standard 10993 for skin sensitization.

In preferred embodiments, the adhesive layer is formed with one or more highly specialized Pressure Sensitive Adhesives (PSAs). PSAs are a type of adhesive which forms a bond when pressure is applied to marry the adhesive with the surface to which the adhesive is applied, in this case, skin. No solvent, water, or heat is needed to activate the adhesive. The one or more pressure-sensitive adhesives can be manufactured from one or more of a group of rubbers, elastomers, acrylic polymers, or the like. Several non-limiting examples of the one or more rubbers, elastomers, and acrylic polymers for use in the adhesive layer of the present invention include solvent-acrylic pressure-sensitive adhesive, solvent-free acrylic pressure-sensitive adhesive, emulsion-acrylic pressure-sensitive adhesive, solvent-rubber pressure-sensitive adhesive, solvent-free rubber pressure-sensitive adhesive, emulsion-rubber pressure-sensitive adhesive, 100-percent solids hot melt rubber pressure-sensitive adhesive, polyisobutylene-based hot-melt pressure-sensitive adhesive, and UV curable pressure-sensitive adhesive.

A common form of rubber finding exemplary use in the PSA of the adhesive layer of the present invention is synthetic rubber made form styrene butadiene rubber (SBR). Although typically more expensive than naturally occurring rubber, such as latex derived from the Hevea brasiliensis rubberwood tree, SBR is exceptionally versatile and stable across a wide range of temperatures. Further, SBR has far superior aging properties and improved oil, grease, and abrasion resistance properties when compared to natural rubber. An additional form of rubber finding exemplary use in the PSA of the adhesive layer is carboxylated styrene-butadiene rubber (XSBR). XSBR is a type of synthetic rubber that has been modified by incorporating carboxylic acid groups into the styrene-butadiene copolymer chain. This modification enhances several properties of the rubber, making it more useful for specific applications compared to non-carboxylated SBR. For example, the incorporation of carboxyl groups into the polymer chain improves the rubber's adhesion properties, abrasion resistance, and mechanical strength. It is conceivable that a blend of two or more rubber types may be used in formulating the pressure-sensitive adhesive for the present invention's adhesive layer.

It is contemplated that the pressure-sensitive adhesive used in the adhesive layer can optionally consist of a blend containing one or more tackifying agents. Further, it is contemplated that the tackifying agents can be manufactured from one or more rosin resins such as those derived from either aged tree stumps (wood rosin), pine trees (methyl ester rosin), sap (gum rosin), or by-products of the paper making process (tall oil rosin). Still further, it is also contemplated that the tackifying agents can be manufactured from one or more hydrocarbon resins such as those made from petroleum-based feedstocks either aliphatic, aromatic, or aliphatic/aromatic, such as liquid C5, liquid C9, polybutene, polyisobutene, DCPD (dicyclopentadiene), aromatic-modified cycloaliphatic hydrocarbon resin, or mixtures of these. Further still, it is contemplated that the tackifying agents can be manufactured from one or more terpene resins such as those made from terpene feedstocks either from wood sources or from citrus fruit. Alternatively, special plastomers such as polyphenylether or linear homopolymers such as Amoco Resin 18 may be selected as potential tackifying agents in certain instances. Yet another contemplated tackifier is liquid rubber, e.g., Isolene 40S. Any number of tackifier agents may be selected or blended depending on the desired properties of the adhesive layer. The one or more optional tackifying agents can be blended or otherwise mixed with the one or more pressure-sensitive adhesives.

In the development of the pressure-sensitive adhesive for the adhesive layer in the present invention, it is a preferred embodiment to select aromatic-modified cycloaliphatic hydrocarbon resin flakes, which are chosen for their optimal tackifying properties. The ideal number-average molecular weight range for these flakes is between 300 to 900 grams per mole. Additionally, for producing the pressure-sensitive adhesive of the present invention's adhesive layer, polyisobutene tackifier has been identified as another preferred choice. Polyisobutene is selected for its viscosity-average molecular weight ranging from 40,000 to 55,000, with a more specific preference for a range between 40,000 and 47,000. The chosen tackifiers should be non-toxic and non-allergenic, ensuring they are safe for use while providing the necessary tackiness or peel strength. This ensures the adhesive can effectively grip or attach to hair, regardless of its size or length.

The pressure-sensitive adhesive for use in the adhesive layer of the present invention can also optionally consist of a blend containing one or more plasticizers or oils. Several non-limiting examples for use in the present invention of preferred plasticizers or oils is medical grade mineral oil or naphthenic process oil. The preferred viscosity of the plasticizers or oils is in the range of 150 Saybolt Universal Seconds (SUS) and 700 Saybolt Universal Seconds (SUS) according to the ASTM D7042 standard, and more preferably between 500 Saybolt Universal Seconds (SUS) and 650 Saybolt Universal Seconds (SUS).

Additionally, the adhesive layer may incorporate colorants, dyes, or pigments. These can be applied to the adhesive layer, the backing layer material, the hair removal strip, or the applicator stick, or a combination of these components. Several non-limiting examples of colorants are titanium dioxide or zinc oxide which can optionally be used to convert the color of the adhesive to fully opaque white.

The adhesive layer of the hair removal strips, or applicator sticks may optionally be infused with one or more soothing agents such as Aloe Barbadensis leaf juice, Ormenis Multicaulis, Enteromorpha Compressa Extract, Vitamin E, or the like, for providing a soothing effect on the skin immediately upon hair removal, reducing the likelihood of irritation or redness. Still further, fragrances such as essential oil may be added or infused into the adhesive layer or backing layer for adding a pleasant aroma to the hair removing apparatus.

Further still, one or more stabilizers may be incorporated into the pressure-sensitive adhesive compound or blend of the adhesive layer according to the present invention to help maintain the properties and performance when exposed to air, light, or heat. Stabilizers are also occasionally referred to as antioxidants and the two terminologies can be understood to convey the same meaning. Preferred stabilizers for the pressure-sensitive adhesive of the present invention include, but are not limited to, pentaerythrityl tetra-di-t-butyl hydroxyhydrocinnamate, sterically hindered phenols, phosphites, and thioethers. Several non-limiting examples of suitable hindered phenols include: 1,3,5-trimethyl 2,4,6-tris (3,5-di-tert-butyl-4-hydroxy-benzyl)-benzene; pentaerythritol tetrakis-3(3,5-di-tert-butyl-4-hydroxyphenyl)-propionate; n-octadecyl-3,5-di-tert-butyl-4-hydroxyphenol)-propionate; 4,4′-methylenebis (2,6-tert-butylphenol); 4,4′-thiobis (6-tert-butyl-o-cresol); 2,6-di-tertbutylphenol; 6-(4-hydroxyphenoxy)-2,4-bis(n-octyl-thio)-1 ,3,5-triazine; di-n-octadecyl 3,5-di-tert-butyl-4-hydroxybenzylphosphonate; 2-(n-octylthio)-ethyl 3,5-di-tert-butyl-4-hydroxy-benzoate; and sorbitol hexa[3-(3,5-di-tert-butyl-4-hydroxyphenyl)-propionate]. The optimal concentration of these stabilizers is 0.5 weight percent of the total weight of the rubber pressure-sensitive adhesive. However, effective stabilizer use can be achieved with concentrations ranging from 0.1 to 5 weight percent of the total rubber pressure-sensitive adhesive composition.

It is further contemplated that suitable stabilizers for use in the pressure-sensitive adhesive can include a blend of pentaerythritol tetrakis[3-[3,5-di-tert-butyl-4-hydroxyphenyl]propionate] and tris(2,4-ditert-butylphenyl)phosphite wherein the optimal weight percent is between 0.1 and 5 weight percent of the total weight of the rubber pressure-sensitive adhesive, and preferably no more than 1 weight percent of the total weight of the rubber pressure-sensitive adhesive.

As contemplated herein, in one variant, the adhesive layer comprises a rubber pressure-sensitive adhesive that comprises a blend of: (i) 100-percent solids hot-melt rubber of between 5 to 20 weight percent of the total weight of the rubber pressure-sensitive adhesive, (ii) mineral oil of between 10 to 40 weight percent of the total weight of the rubber pressure-sensitive adhesive, (iii) C5 aliphatic liquid tackifying resin of between 30 to 60 weight percent of the total weight of the rubber pressure-sensitive adhesive, (iv) aromatic-modified, cycloaliphatic hydrocarbon resin flakes of between 10 to 30 weight percent of the total weight of the rubber pressure-sensitive adhesive, (v) polyisobutene of between 0.25 to 2 weight percent of the total weight of the rubber pressure-sensitive adhesive, and (vi) stabilizer of between 0.25 to 2 weight percent of the total weight of the rubber pressure-sensitive adhesive.

In another variant, it is contemplated that the adhesive layer comprises the following components as depicted according to the weight percentage of the total weight of the rubber pressure-sensitive adhesive:
7 to 12 weight percent: 100-percent Solids Hot-Melt Rubber
12 to 20 weight percent: Mineral Oil
45 to 55 weight percent: C5 Aliphatic Liquid Tackifying Resin
18 to 25 weight percent: Aromatic Modified, Cycloaliphatic Hydrocarbon Resin Flakes
0.5 to 1 weight percent: Polyisobutene
0.25 to 1 weight percent: Stabilizer

In still another variant, it is contemplated that the adhesive layer more preferably comprises the following components as depicted according to the weight percentage of the total weight of the rubber pressure-sensitive adhesive:
10.30 weight percent: 100-percent Solids Hot-Melt Rubber
16.17 weight percent: Mineral Oil
49.95 weight percent: C5 Aliphatic Liquid Tackifying Resin
22.43 weight percent: Aromatic Modified, Cycloaliphatic Hydrocarbon Resin Flakes
0.65 weight percent: Polyisobutene
0.5 weight percent: Stabilizer

The adhesive layer of the present invention can be said to be a custom 100-percent solids hot-melt rubber pressure-sensitive adhesive that is solvent-free. Additional formulation modifications are possible and contemplated based on a given need.

The adhesive layer of the present invention preferably demonstrates a loop tack value as discussed below, which is a measure of the tack force and/or strength of the adhesive layer when tested using the international standard test method ASTM D6195, or the like. In one variant, it is contemplated that the loop tack is between 2 pounds per inch and 75 pounds per inch. Further, the adhesive layer of the present invention preferably demonstrates a peel adhesion, which is a measure of the force required to remove the adhesive layer from a testing plate using the international standard test method ASTM D3330, or the like. In one variant, it is contemplated that the peel adhesion is between 2 pounds per inch and 60 pounds per inch. The custom-made, 100-percent solids hot-melt rubber pressure-sensitive adhesive of the adhesive layer preferably has a minimum shelf life of one to two years from the date of manufacture when stored at 70 degrees Fahrenheit and 50 percent relative humidity.

### Environmental Considerations

Responding to the rising demand for eco-friendly grooming solutions, the hair removal strip of the present invention are crafted with an emphasis on minimizing environmental impact. Carefully chosen materials and adhesives are not just effective and safe, but also environmentally sustainable, and vegan whenever possible. This approach includes the use of a tailor-made, solvent-free hot-melt rubber adhesive that consists entirely of solids, specifically designed for gripping hair. The contemplated adhesive is notable for being completely free from volatile organic compounds (VOCs) and pollutants. Moreover, the solid rubber used is of such purity that it leaves no residual monomers or inhibitors, thereby preventing out-gassing and migration. Additionally, the manufacturing process of this adhesive is environmentally considerate, requiring minimal energy and no water. By way of example, compared to solvent-based adhesives, 100% solids hot-melt rubber manufacturing can reduce energy requirements by up to 95%. In a continued effort to be eco-conscious, the invention aims to eliminate the use of non-recyclable and non-biodegradable plastics in both the strip and the stick components as much as possible.

### Optional Adhesive Formulation Adjustments and Performance Adjustments

Adjustments to the adhesive formulation can be made to enhance performance. For example, modifying the weight percent of certain tackifiers as a percentage of the total weight of the rubber pressure-sensitive adhesive can optimize the adhesive strength and flexibility, resulting in a material that is highly effective yet gentle on the skin.

The adhesive layer is designed to exhibit a high loop tack value, as measured by standard tests like ASTM D6195, indicating strong tack force and strength. Similarly, its peel adhesion, measured by tests such as ASTM D3330, is maintained at a high level, ensuring effective hair removal. The chosen rubber pressure-sensitive adhesive demonstrates low-to-moderate surface energy performance, contributing to a long shelf life, a critical factor in maintaining the efficacy of the product. Further, for hair removal, it's crucial to strike a balance between adhesion to hair and minimal adhesion to skin. Low-to-moderate surface energy performance in a rubber pressure-sensitive adhesive means it is engineered to effectively stick to hair for removal while not adhering too strongly to skin. This balance ensures effective hair removal without causing excessive discomfort or damage to the skin surface. Further still, an adhesive with low-to-moderate surface energy performance is more likely to be removed from the skin cleanly, without leaving behind sticky residues that can irritate the skin or require harsh cleaning to remove. Although a few embodiments have been described in detail above, other modifications are possible.

### Exemplary Methods

The application of these hair removing strips is designed to be user-friendly and efficient. Users can select the appropriate size and shape of the strip based on the area of hair removal. The strip is then pressed firmly onto the skin against the direction of hair growth and swiftly removed in the opposite direction. This quick and easy process makes the strips an ideal choice for both routine grooming and quick touch-ups. Of particular interest is that this apparatus works very effectively even on hot and wet shower skin. That is, the adhesive layer of the present invention, which comprises a custom 100-percent solids hot-melt rubber pressure-sensitive adhesive, works quite effectively even when mildly wet. This attribute is attributable to the hydrophobic nature of the 100-percent solids rubber, which repels water. Further, due to the absence of solvents in the 100-percent solids hot-melt rubber pressure-sensitive adhesive, there is an absence of compounds that would otherwise become compromised by the presence of water. The ability to function even when mildly wet is a strong competitive advantage over conventional wax-based hair removal treatments which become deactivated in the presence of water. An additional benefit of the custom hot-melt rubber pressure-sensitive adhesive strips for hair removal is their ability to adhere effectively across a wide temperature range, from about −65° F. to 150° F. While these extreme temperatures are likely beyond the recommended conditions for typical use, it indicates that the strips are versatile enough to perform well in virtually any environment an end user might encounter, within practical limits.

In specific implementations, the hair removal strips are designed with an adhesive-free perimeter edge around the hair removal section, known as a ‘dry edge’. This design can be achieved by initially applying the adhesive layer onto a release liner. Subsequently, this adhesive-coated liner is formed into the desired strip shape through die-cutting or laser-cutting methods. The shaped adhesive layer is then affixed to a backing layer, which is deliberately made with a slightly larger perimeter. Finally, the combined layers are subject to a further round of die-cutting or laser-cutting to ensure precision in the final hair removal strip dimensions. For user convenience, the packaging of these strips includes detailed instructions and recommendations for use. These guidelines cover various aspects such as optimal skin preparation, the best techniques for strip application and removal, and aftercare advice to maintain skin health post hair removal.

### Additional Configuration Considerations

Thus, specific embodiments of apparatus, systems, and methods for facial and body hair removing and sculpting that utilize new and improved hair removing strips and an adhesive formulation have been disclosed.

It should be apparent, however, to those skilled in the art that many more modifications besides those already described are possible without departing from the inventive concepts herein, including additional alternative structural and functional designs as disclosed from the principles herein. Thus, while embodiments and applications have been illustrated and described, it is to be understood that the disclosed embodiments are not limited to the precise construction and components disclosed herein. Various modifications, changes, and variations, which will be apparent to those skilled in the art, may be made in the arrangement, operation and details of the apparatus and methods disclosed herein without departing from the spirit and scope of the disclosure. Thus, it is intended that the present disclosure covers the modifications and variations of the embodiments disclosed above provided that the modifications and variations come within the scope of any claims and their equivalents.

The inventive subject matter, therefore, is not to be restricted except in the spirit of the appended claims. Moreover, in interpreting both the specification and the claims, all terms should be interpreted in the broadest possible manner consistent with the context. Throughout this specification, some embodiments have used the expressions “comprises,” “comprising,” “includes,” “including,” “has,” “having,” or any other variation thereof, all of which are intended to cover a non-exclusive inclusion. For example, a process, method, article, or apparatus that comprises a list of elements is not necessarily limited to only those elements but may include other elements not expressly listed or inherent to such process, method, article, or apparatus. In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise. Where the specification or claims refer to at least one of something selected from the group consisting of A, B, C, . . . and N, the text should be interpreted as requiring only one element from the group, not A plus N, or B plus N, etc.

As used herein any reference to any of “one embodiment” or “an embodiment,” “one variant” or “a variant,” and “one implementation” or “an implementation” means that a particular element, feature, structure, or characteristic described in connection with the embodiment, variant or implementation is included in at least one embodiment, variant or implementation. The appearances of such phrases in various places in the specification are not necessarily all referring to the same embodiment, variant or implementation.

It will be recognized that while certain aspects of the technology are described in terms of a specific sequence of steps of a method, these descriptions are only illustrative of the broader methods of the disclosure and may be modified as required by the particular application. Certain steps may be rendered unnecessary or optional under certain circumstances. Additionally, certain steps or functionality may be added to the disclosed implementations, or the order of performance of two or more steps permuted. All such variations are considered to be encompassed within the disclosure disclosed and claimed herein.

While the above detailed description has shown, described, and pointed out novel features of the disclosure as applied to various implementations, it will be understood that various omissions, substitutions, and changes in the form and details of the apparatus, article, method, or process illustrated may be made by those skilled in the art without departing from the disclosure. The foregoing description is of the best mode presently contemplated of carrying out the principles of the disclosure. This description is in no way meant to be limiting, but rather should be taken as illustrative of the general principles of the technology. The scope of the disclosure should be determined with reference to the claims.

What is claimed is:

1. A hair removal and sculpting apparatus, comprising:
a hair removal strip comprising a pull-tab portion and a hair removal portion;
wherein the hair removal portion is configured to conform to a portion of a human body for removing hair; and
wherein the hair removal portion further comprises a backing layer, an adhesive layer coupled to the backing layer, and a release liner removably coupled to the adhesive layer; and
wherein the adhesive layer further comprises a rubber pressure-sensitive adhesive.

2. The hair removal and sculpting apparatus of claim 1, wherein the backing layer is selected from a group consisting of woven fabrics, non-woven fabrics, non-woven interfacing, fusible webs, and spunbond fabrics.

3. The hair removal and sculpting apparatus of claim 1, wherein the rubber pressure-sensitive adhesive further comprises 100-percent solids hot-melt rubber.

4. The hair removal and sculpting apparatus of claim 1, wherein the rubber pressure-sensitive adhesive further comprises mineral oil.

5. The hair removal and sculpting apparatus of claim 1, wherein the rubber pressure-sensitive adhesive further comprises C5 aliphatic liquid tackifying resin.

6. The hair removal and sculpting apparatus of claim 1, wherein the rubber pressure-sensitive adhesive further comprises aromatic-modified, cycloaliphatic hydrocarbon resin flakes.

7. The hair removal and sculpting apparatus of claim 1, wherein the rubber pressure-sensitive adhesive further comprises polyisobutene.

8. The hair removal and sculpting apparatus of claim 1, wherein the rubber pressure-sensitive adhesive further comprises stabilizer.

9. The hair removal and sculpting apparatus of claim 1, wherein the release liner is coated with silicone.

10. A hair removal and sculpting apparatus, comprising:
a hair removal strip comprising a pull-tab portion and a hair removal portion;
wherein the hair removal portion is configured to conform to a portion of a human body for removing hair;
wherein the hair removal portion further comprises a backing layer, an adhesive layer coupled to the backing layer, and a release liner removably coupled to the adhesive layer;
wherein the adhesive layer further comprises a rubber pressure-sensitive adhesive; and
wherein the rubber pressure-sensitive adhesive further comprises 100-percent solids hot-melt rubber.

11. The hair removal and sculpting apparatus of claim 10, wherein the backing layer is selected from a group consisting of woven fabrics, non-woven fabrics, non-woven interfacing, fusible webs, and spunbond fabrics.

12. The hair removal and sculpting apparatus of claim 10, wherein the 100-percent solids hot-melt rubber further comprises between 5 to 20 weight percent of a total weight of the rubber pressure-sensitive adhesive.

13. The hair removal and sculpting apparatus of claim 12, wherein the rubber pressure-sensitive adhesive further comprises mineral oil of between 10 to 40 weight percent of the total weight of the rubber pressure-sensitive adhesive.

14. The hair removal and sculpting apparatus of claim 13, wherein the rubber pressure-sensitive adhesive further comprises C5 aliphatic liquid tackifying resin of between 30 to 60 weight percent of the total weight of the rubber pressure-sensitive adhesive.

15. The hair removal and sculpting apparatus of claim 14, wherein the rubber pressure-sensitive adhesive further comprises aromatic-modified, cycloaliphatic hydrocarbon resin flakes of between 10 to 30 weight percent of the total weight of the rubber pressure-sensitive adhesive.

16. The hair removal and sculpting apparatus of claim 15, wherein the rubber pressure-sensitive adhesive further comprises polyisobutene of between 0.25 to 2 weight percent of the total weight of the rubber pressure-sensitive adhesive.

17. The hair removal and sculpting apparatus of claim 16, wherein the rubber pressure-sensitive adhesive further comprises stabilizer of between 0.25 to 2 weight percent of the total weight of the rubber pressure-sensitive adhesive.

18. The hair removal and sculpting apparatus of claim 10, wherein the release liner is coated with silicone.

19. A hair removal and sculpting apparatus, comprising:
a hair removal strip comprising a pull-tab portion and a hair removal portion;
wherein the hair removal portion is configured to conform to a portion of a human body for removing hair;
wherein the hair removal portion further comprises a backing layer, an adhesive layer coupled to the backing layer, and a release liner removably coupled to the adhesive layer; and
wherein the adhesive layer further comprises a rubber pressure-sensitive adhesive comprising 100-percent solids hot-melt rubber, mineral oil, tackifying resin, hydrocarbon resin flakes, Polyisobutene, and stabilizer.
